(19) United States
(12) Patent Application Publication
(10) Pub. No.: US 2013/0205250 A1
(43) Pub. Date: Aug. 8, 2013

(54) INFORMATION PROCESSING APPARATUS, INFORMATION PROCESSING METHOD, AND COMPUTER-READABLE MEDIUM

(71) Applicant: Canon Kabushiki Kaisha, Tokyo (JP)

(72) Inventor: Hitoshi Osaka, Yokohama-shi (JP)

(73) Assignee: CANON KABUSHIKI KAISHA, Tokyo (JP)

(21) Appl. No.: 13/682,448

(22) Filed: Nov. 20, 2012

(30) Foreign Application Priority Data
Feb. 8, 2012 (JP) 2012-025536

(51) Int. Cl. G06F 3/0481

(52) U.S. Cl. CPC G06F 3/0481
USPC 715/803

(57) ABSTRACT

An apparatus installed with an operating system having a plurality of application execution environments different in user interface configuration for operating an application, comprises: confirmation unit which, when operating a first application which operates on a first application execution environment, confirms whether a second application which operates on a second application execution environment and is associated with the first application is installed on the second application execution environment; and control unit which, when selecting data from a data selection screen displayed by the second application after the confirmation unit has confirmed that the second application associated with the first application is installed on the second application execution environment, stores the data in a second folder accessible by operations fewer than operations when accessing a first folder in which the data stored on the first application execution environment is stored.

### BACKGROUND OF THE INVENTION

1. Field of the Invention

The present invention relates to an information processing apparatus, information processing method, and computer-readable medium. The present invention particularly relates to the control of files to be displayed in two application execution environments different in operability.

2. Description of the Related Art

Recently, computer's operation environments have been diversified. While conventionally used information input using a keyboard and mouse exists, information input performed by touch operations using human fingers, for example, a touch operation using a capacitance touch panel is spreading. It is determined that in Windows 8 as the next-generation operating system (OS) of Microsoft, U.S.A., these operation environments having different styles are installed as one OS in one computer.

There is an operation environment that has a style in which a plurality of windows are simultaneously displayed as in the previous Windows° OS, and is basically suitable for an operation using a mouse and keyboard. In Windows 8, this operation environment is called “Desktop environment”. On the other hand, there is an operation environment in which operation buttons for accepting operations are large and one application basically operates by occupying a full screen, and which is suitably used by touch operations using human fingers. In Windows 8, this operation environment is called “Metro environment”.

Japanese Patent Laid-Open No. 2011-203939 has been disclosed as a prior art for solving the problem that it is difficult to find files dispersed in various folders. In Japanese Patent Laid-Open No. 2011-203939, a folder is generated at a regular or irregular update timing based on the common feature of the contents of files, and files having common contents are placed in each folder.

In the operation environment “Metro environment” of Windows 8, limitations on the user interface are determined as the design guidelines of the OS, in order to achieve particularly a simple operation feeling. Especially in a file selection screen displayed by an application, the display of a file hierarchy using a conventional tree view is inhibited. In the file selection screen, therefore, the contents of only one folder can be displayed at one time. Accordingly, to move from one folder to another, it is necessary to trace the hierarchical structure to ascend folder layers one by one, or open a folder and descend folder layers one by one. When using a plurality of files existing over a plurality of folder layers while switching these files, therefore, the number of operation procedures in the environment that displays the contents of only one folder is larger than that of a method such as a tree view capable of two-dimensionally accessing folders.

Japanese Patent Laid-Open No. 2011-203939 has disclosed a technique of using files existing over a plurality of folder layers with a few procedures. However, in an OS such as Windows 8 in which different operation environments coexist, these operation environments (Desktop environment and Metro environment in Windows 8) cannot cooperate to effectively improve the usability of file operations.

### SUMMARY OF THE INVENTION

According to one aspect of the present invention, there is provided an information processing apparatus installed with an operating system having a plurality of application execution environments different in user interface configuration for operating an application, comprising: a confirmation unit configured to, when operating a first application which operates on a first application execution environment, confirm whether a second application which operates on a second application execution environment and is associated with the first application is installed on the second application execution environment; and a storing control unit configured to, when selecting data from a data selection screen displayed by the second application after the confirmation unit has confirmed that the second application associated with the first application is installed on the second application execution environment, store the data in a second folder accessible by operations fewer than operations when accessing a first folder in which the data stored on the first application execution environment is stored.

According to another aspect of the present invention, there is provided an information processing apparatus installed with an operating system having a plurality of application execution environments different in user interface configuration for operating an application, comprising: a confirmation unit configured to, when operating a first application which operates on a first application execution environment, confirm whether a second application which operates on a second application execution environment and is associated with the first application is activated on the second application execution environment; and a storing control unit configured to, when selecting data from a data selection screen displayed by the second application after the confirmation unit has confirmed that the second application associated with the first application is activated on the second application execution environment, store the data in a second folder accessible by operations fewer than operations when accessing a first folder in which the data stored on the first application execution environment is stored.

According to another aspect of the present invention, there is provided an information processing method of an information processing apparatus installed with an operating system having a plurality of application execution environments different in user interface configuration for operating an application, comprising: confirming, when operating a first application which operates on a first application execution environment, whether a second application which operates on a second application execution environment and is associated with the first application is installed on the second application execution environment; and storing, when selecting data from a data selection screen displayed by the second application after it is confirmed in the confirming step that the second application associated with the first application is installed on the second application execution environment, the data in a second folder accessible by operations fewer than operations when accessing a first folder in which the data stored on the first application execution environment is stored.

According to another aspect of the present invention, there is provided an information processing method of an information processing apparatus installed with an operating system having a plurality of application execution environments different in user interface configuration for operating an application, comprising: confirming, when operating a first application which operates on a first application execution environment, whether a second application which operates on a second application execution environment and is associated with the first application is activated on the second application execution environment; and storing, when selecting data from a data selection screen displayed by the second application after it is confirmed in the confirming step that the second application associated with the first application is activated on the second application execution environment, the data in a second folder accessible by operations fewer than operations when accessing a first folder in which the data stored on the first application execution environment is stored.

According to another aspect of the present invention, there is provided a non-transitory computer-readable medium storing a program which causes a computer to function as: a confirmation unit configured to, when operating a first application which operates on a first application execution environment, confirm whether a second application which operates on a second application execution environment and is associated with the first application is installed on the second application execution environment; and a storing control unit configured to, when selecting data from a data selection screen displayed by the second application after the confirmation unit has confirmed that the second application associated with the first application is installed on the second application execution environment, store the data in a second folder accessible by operations fewer than operations when accessing a first folder in which the data stored on the first application execution environment is stored.

According to another aspect of the present invention, there is provided a non-transitory computer-readable medium storing a program which causes a computer to function as: a confirmation unit configured to, when operating a first application which operates on a first application execution environment, confirm whether a second application which operates on a second application execution environment and is associated with the first application is activated on the second application execution environment; and a storing control unit configured to, when selecting data from a data selection screen displayed by the second application after the confirmation unit has confirmed that the second application associated with the first application is activated on the second application execution environment, store the data in a second folder accessible by operations fewer than operations when accessing a first folder in which the data stored on the first application execution environment is stored.

The present invention can improve the usability of filer operations even when an OS has a plurality of execution environments and these execution environments have different operation environments.

Further features of the present invention will become apparent from the following description of exemplary embodiments (with reference to the attached drawings).

### BRIEF DESCRIPTION OF THE DRAWINGS

FIG. 1 is a view showing an example of the hardware configuration of an information processing apparatus;

FIG. 2 is a view showing an example of the software configuration of the information processing apparatus;

FIG. 3 is a view showing an example of a multi-window GUI;

FIG. 4 is a view showing an arrangement example of a first environment application window having a pane structure;

FIG. 5 is a view showing an arrangement example of the first environment application window having the pane structure;

FIG. 6 is a view showing a display example of a second environment application;

FIG. 7 is a view showing a display example of the second environment application;

FIG. 8 is an overall flowchart according to the first embodiment;

FIG. 9 is sub-flowchart 1 according to the first embodiment;

FIG. 10 is sub-flowchart 2 according to the first embodiment;

FIG. 11 is sub-flowchart 3 according to the first embodiment;

FIG. 12 is sub-flowchart 4 according to the first embodiment;

FIG. 13 is a view showing a description example of an information file according to the first embodiment;

FIG. 14 is a view showing an arrangement example of a first environment application window according to the second embodiment;

FIG. 15 is a sub-flowchart according to the second embodiment;

FIG. 16 is a view showing a description example of an information file according to the second embodiment;

FIG. 17 is an overall flowchart according to the fourth embodiment;

FIG. 18 is a sub-flowchart according to the fourth embodiment;

FIG. 19 is a view showing an example of a monitoring setting screen according to the fourth embodiment;

FIG. 20 is a view showing an example of an operation condition setting screen according to the fifth embodiment;

FIG. 21 is a sub-flowchart according to the fifth embodiment;

FIG. 22 is a view showing a display example of an application according to the first embodiment;

FIG. 23 is a view showing an arrangement example of an application package according to the first embodiment;

FIG. 24 is a view showing a display example of an application according to the second embodiment; and

FIG. 25 is a view showing a display example of an application according to the third embodiment.

### DESCRIPTION OF THE EMBODIMENTS

Embodiments for carrying out the present invention will be explained below with reference to the accompanying drawings.

[System Configuration Views]

(Hardware Configuration)

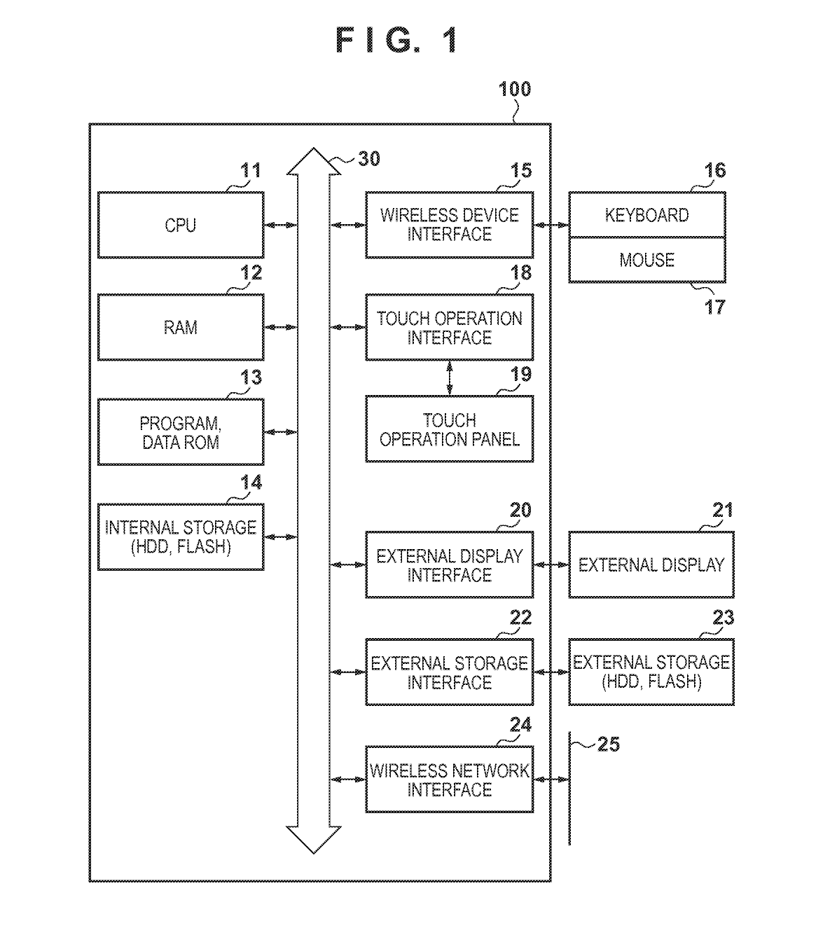

An embodiment of a system according to the present invention will be explained. FIG. 1 shows a computer 100 as an information processing apparatus capable of executing the process (to be described later) of this embodiment. The computer 100 includes a CPU 11, RAM 12, ROM 13, internal storage 14, wireless device interface 15, touch operation interface 18, external display interface 20, external storage interface 22, and wireless network interface 24.

The CPU 11 controls the constituent elements of the computer 100. The RAM 12 is used as a work area when processing various programs. The ROM 13 is a memory storing programs and data to be used in processing. The internal storage 14 is used to store, read, and write programs and data in addition to the ROM 13 and RAM 12, and is a hard disk (HDD) or flash memory. The wireless device interface 15 communicates with a keyboard 16 and mouse 17 as external input devices by using a wireless technology such as Bluetooth®.

The touch operation interface 18 exchanges input information with a touch operation panel 19 such as a capacitance touch panel that displays information and can be used by touch operations. The external display interface 20 exchanges display information with an external display 21 that is used to display information in addition to the touch operation panel 19. The external storage interface 22 exchanges data with an external storage 23 not incorporated into the computer 100. The wireless network interface 24 exchanges signals with a communication network 25 such as a WAN or LAN.

Note that the constituent elements of the computer 100 are connected via a system bus 30. Note also that the computer 100 is not limited to this configuration and can also include another constituent element. The computer 100 can be a notebook PC or another portable terminal.

(Software Configuration)

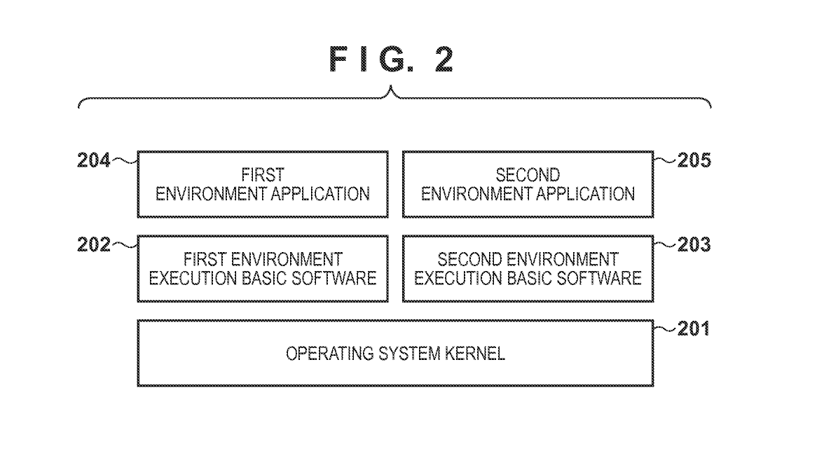

FIG. 2 shows a configuration example of an OS (Operating System) as a software execution environment in which the process of this embodiment is executed. A kernel 201 of the OS exists as the basis on the computer 100. On the kernel 201, basic software (to be referred to as first environment software 202 hereinafter) of an application execution environment as a first execution environment and basic software (to be referred to as second environment software 203 hereinafter) of an application execution environment as a second execution environment exist in parallel. On each application execution environment, an application for the environment can be executed. An application to be executed on the first application execution environment is a first environment application 204. An application to be executed on the second application execution environment is a second environment application 205.

That is, the first environment application (first application) operates on the first environment software (first execution environment), and the second environment application (second application) operates on the second environment software (second execution environment). Each application disclosed in this embodiment is executed in the corresponding environment application layer while exchanging information with the kernel 201 via the first environment software 202 or second environment software 203.

“Kernel” herein mentioned is a portion as the core of an OS designed to have a hierarchical structure, and has a function of providing an interface that abstracts a CPU, memory, input/output hardware, and the like, and enables hardware and software to communicate with each other. Note that in this embodiment as shown in FIG. 2, the two execution environments physically exist on one computer 100. However, it is possible to similarly carry out the present invention even when three or more execution environments exist.

In this embodiment, the user recognizes these two applications as different operation environments. Examples are two operation environments such as “Desktop environment” and “Metro environment” of Windows 8. In this specification, an explanation will be made by taking Desktop environment and Metro environment as examples. Hereafter, an explanation will be made by assuming that Desktop environment is “first execution environment” (“first environment” hereinafter), and Metro environment is “second execution environment” (“second environment” hereinafter). That is, “first environment” corresponds to the first environment software 202, and “second environment” corresponds to the second environment software 203.

(GUI in First Environment)

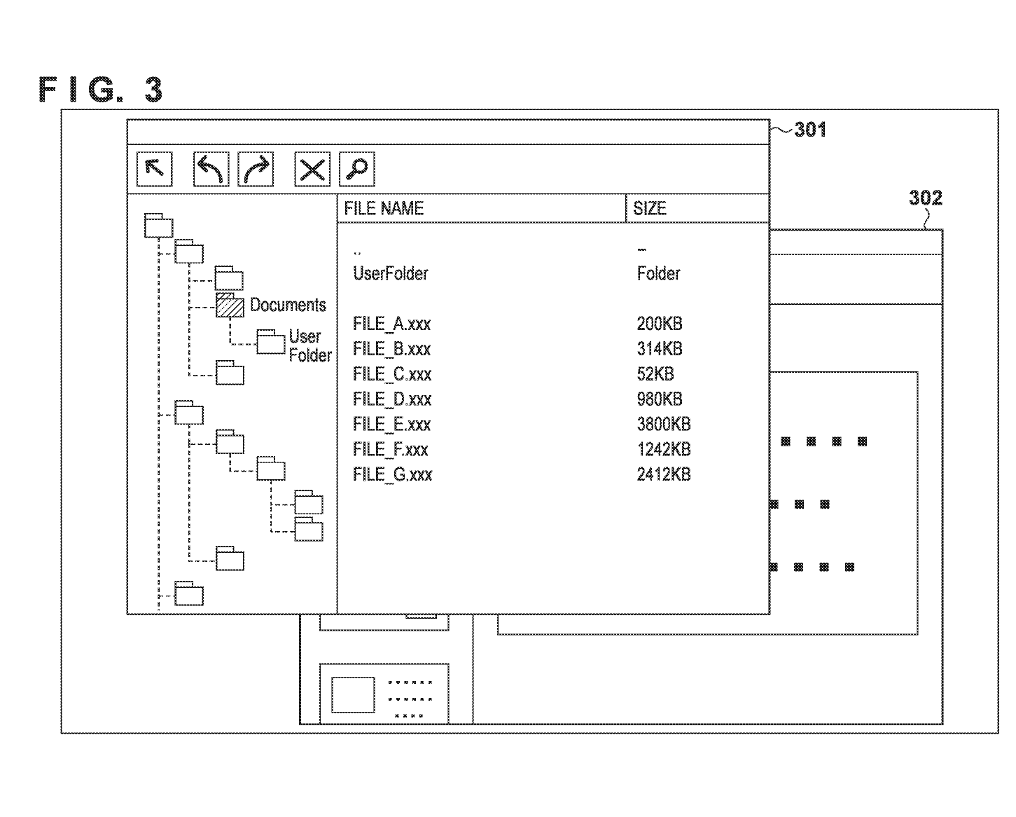

In the first environment, an operation environment in a GUI (Graphical User Interface) environment can be used. As shown in FIG. 3, a general form is to simultaneously display windows 301, 302, and the like on the display screen, and perform an operation in the foreground window while switching the windows.

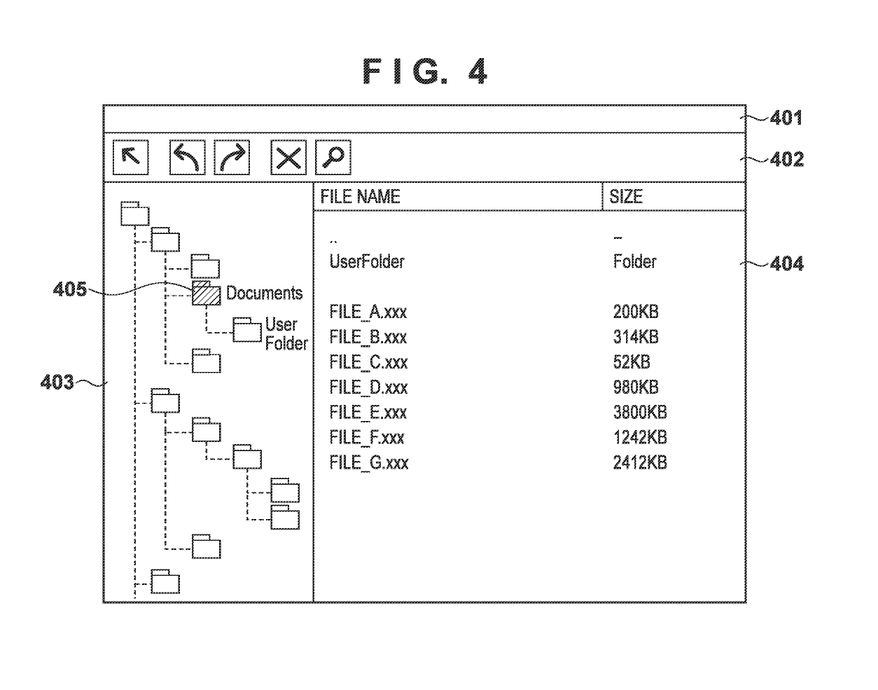

Some applications to be executed in the first environment have a pane structure as shown in FIG. 4. “Pane” will be explained below. For example, three panes 402, 403, and 404 exist in an application screen 401 shown in FIG. 4. That is, panes are regions clearly divided in a window, and the individual regions express different roles. More specifically, each pane constructing a window can display contents matching the purpose. Note that panes constructing a window are not unique to each application, and the display position and display contents of each pane can be changed by setting or the like.

Each pane shown in FIG. 4 will be explained. The pane 403 has, on the screen, a hierarchical display form generally called “tree view” that displays the hierarchical structure of folders of a file management system. The pane 404 displays files as the contents stored in one folder of the folder hierarchical structure, and a list of lower folders. The pane 402 displays a portion called a tool bar constructed by icons corresponding to various operation commands executable with respect to files and folders.

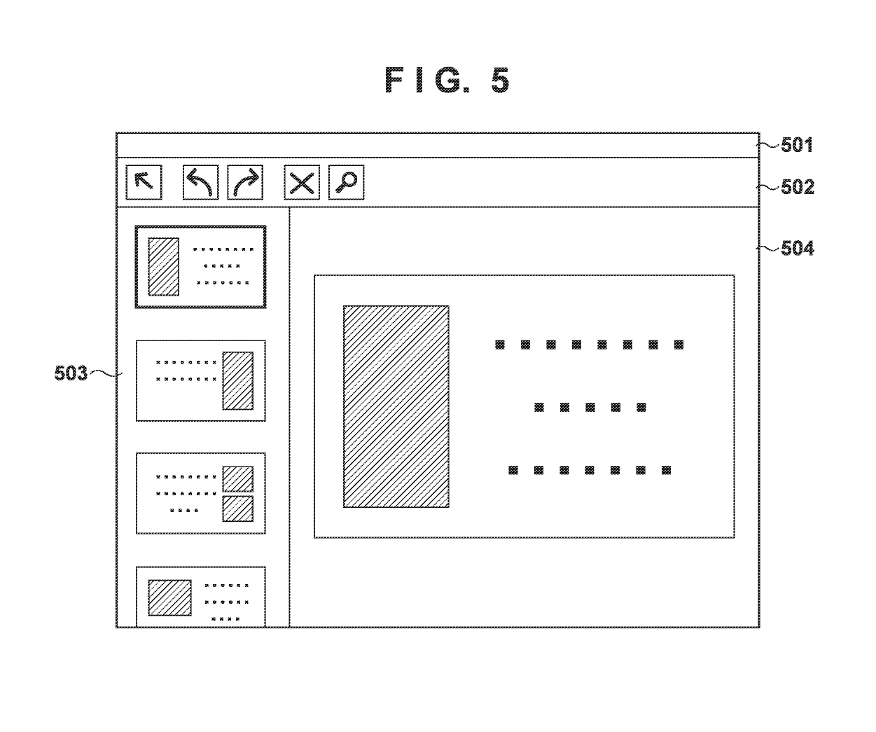

As another example, an application screen 501 shown in FIG. 5 includes a tool bar pane 502, a thumbnail pane 503 for displaying each page of a document as a small thumbnail image, and a page display pane 504 for displaying one page of the document as a large image. The arrangement as shown in FIG. 5 is generally used in a presentation application for displaying and editing slides.

In the conventional GUI environment, a window divided into a plurality of regions (panes) each having a distinct role as described above is generally used as a display form of an application. This display form is used in the first environment of this embodiment.

(GUI in Second Environment)

On the other hand, the second environment is designed to improve the operability of, for example, a touch panel display when using fingers or a stylus pen. However, the conventional operation using a mouse and keyboard can also be performed in the second environment.

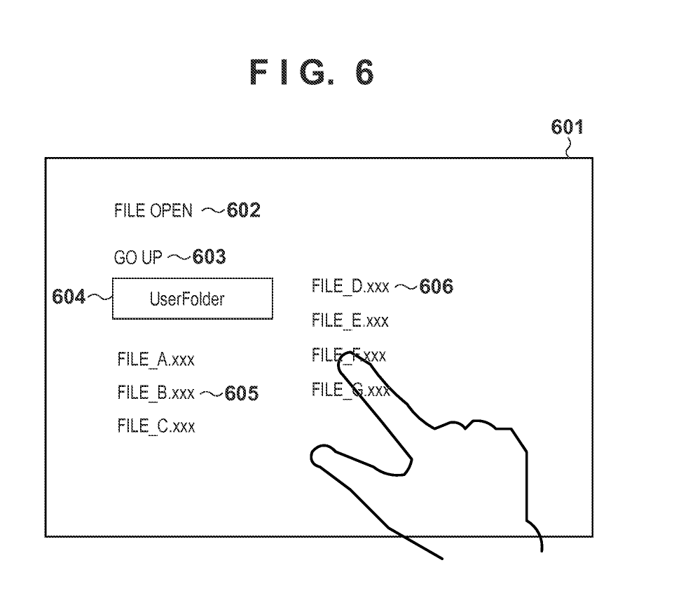

FIG. 6 shows an example of the GUI in the second environment. An application screen 601 shown in FIG. 6 indicates a data selection screen for designating a file to be opened in an application. In this example, a single screen for “designating a file to be opened” as one function is displayed by using the full screen, and a plurality of windows as shown in FIG. 3 in the first environment are not displayed. Also, the window is not constructed by a plurality of panes as shown in FIG. 4. Note that FIG. 6 is an example in which the contents of the folder 405 shown in FIG. 4 are displayed.

The application screen 601 contains a title item 602 indicating a “File Open” function, and list items 605 and 606 indicating lists of files existing in the folder. When touching the character string of a file name in the list items 605 and 606, a desired file can be opened in the application. In addition, the application screen 601 contains a folder item 604 for displaying a lower “UserFolder” folder in the folder. When touching the rectangular area of the folder item 604, the display location can move into the “UserFolder” folder. The application screen 601 further contains a “Go Up” item 603 for moving the display location to an upper folder layer.

In the application screen 601 shown in FIG. 6, not only the full screen is narrowed down to one function so that the user can comfortably use the GUI with a rough touch operation using fingers, but also the size of each item is large enough to allow a rough touch operation by fingers. These features are mainly designed based on the assumption that the operation is performed on a readily portable small-sized screen such as that of a tablet computer or smartphone.

Instead, it is impossible to display a plurality of folder layers on the screen like the tree view as indicated by the pane 403 shown in FIG. 4. In the application screen 601 shown in FIG. 6, therefore, the user must move to folder layers in order by selecting the folder item 604 or the “Go Up” item 603. This complicates the operation of folder movement. This is so because the tree view itself is constructed by small display elements, and this makes an accurate touch operation difficult. Therefore, the screen is thus designed in order to avoid use in the touch environment. The present situation is that the file selection screen displayed in Metro environment of Windows 8 has the same operation cumbersomeness as that of the application screen 601 shown in FIG. 6.

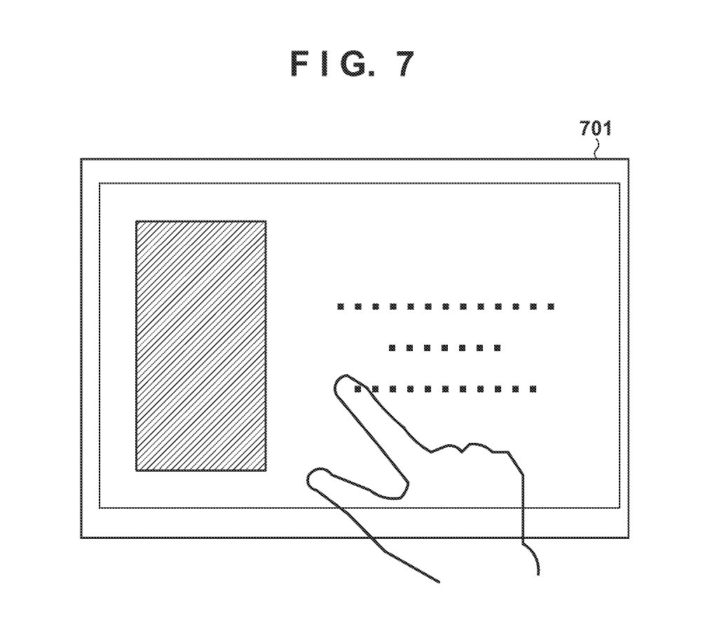

An application screen 701 shown in FIG. 7 shows a display example of the second environment application 205, when the application screen 501 shown in FIG. 5 is reformed to be suitable for the second environment. Generally, it is possible to enlarge or reduce a document image and switch pages to be displayed by using various touch operations as the well-known techniques. Examples of generally known touch operations are “pinch-in/pinch-out” and “flick”. The “pinch-in/pinch-out” operation is mainly used to enlarge or reduce an image by opening a plurality of fingers outward or closing them inward. The “flick” operation is an operation of flicking the screen with a finger, and mainly used to switch display images. For example, when the second environment application 205 is used to browse documents on a tablet computer or the like, a speaker can hand over the tablet computer displaying a document on the screen to a listener, thereby sharing information and communicating with each other. Details of the operation of the application are not the scope of this embodiment, and hence will be omitted. However, the display method using the full screen as shown in FIG. 7 is the feature of the second environment.

[Use Case]

As described above, the two application execution environments have a large difference in operability. When two different application execution environments like these coexist on one computer, it is expected to selectively use their characteristics in respective more suitable scenes.

For example, the first environment that displays a plurality of windows and uses a tree view and the like is capable of efficient works but unsuitable for touch operations. Therefore, the first environment is presumably mainly used in an office in the same manner as that for the conventional computers by connecting a keyboard and mouse by wired connection or wirelessly.

On the other hand, the second environment is capable of intuitive rapid touch operations, and hence is probably used in communication with a customer or partner in a place where the user has gone. In particular, the second environment is perhaps mainly used for “browsing”, for example, in presentation using a plurality of files, or when the user communicates with a customer by handing over a computer or the like to the customer and watching materials on the screen together.

When the cases as described above are taken into consideration, file selection in the second environment is required to have the operability that smoothens communication by rapidly and smoothly opening a target file. However, it is difficult to achieve this operability by the file selection screen having the limitations shown in FIG. 6. Practical embodiments of file control for solving this problem will be explained below.

### First Embodiment

### Relationship between Software Applications in Computer

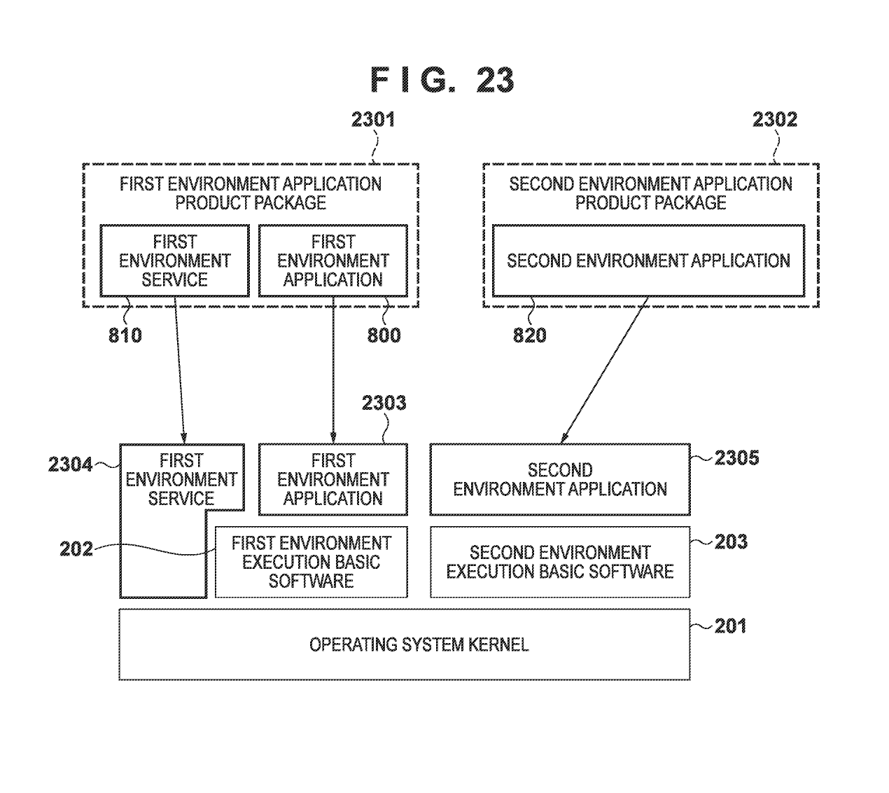

Before the explanation of procedures, configuration examples of assumed application products will be explained. As shown in FIG. 23, products of the first embodiment include a product package 2301 of a first environment application, and a product package 2302 of a second environment application. Each of the product packages 2301 and 2302 is an application that can be used singly. In this embodiment, however, the product package 2302 is an optional product of the product package 2301, and has the relationship that when the user having the product package 2301 uses the product package 2302, he or she can conveniently use various functions implemented by cooperation between the packages.

That is, a first environment application 800 operates on the first environment, and a second environment application 820 operates on the second environment, but the two applications are associated with each other. “(Applications are) associated with each other” herein mentioned indicates that applications can execute predetermined processing by cooperating with each other. Accordingly, the present invention is not limited to the application relationship between a product package and its optional product as described above.

The product package 2301 is installed in the computer 100 by using a conventionally general installer. The relationship with the OS after the installation is as indicated by an application 2303 and service 2304 shown in FIG. 23. “Service” herein mentioned is the form of an application, in which the application is always operating in the background without user's intentional activation, and capable of monitoring the system activities. The application 2303 and service 2304 are arranged on the execution basic software of the first environment (the first environment software 202). However, as indicated by the service 2304, a service 810 directly exchanges information with the kernel 201 in some cases.

On the other hand, in Windows 8, the product package 2302 is installed as an application 2305 on the execution basic software of the second environment (the second environment software 203) via a specific installation environment called Windows App Store.

After the installation, each of the applications 2303 and 2305 can freely be activated by a method provided by the OS. In Windows 8, for example, each application can be activated by the user by touching the icon on the start screen. Also, the service 2304 is so installed as to be registered in the OS, and automatically activated when the computer is activated.

As described above, the applications 2303 and 2305 and service 2304 can cooperate with each other as in this embodiment, although they are separated as software components. It is of course also possible to distribute a second environment application product package simultaneously with a first environment application.

Also, the first embodiment will be explained based on the premise that all applications know each other's application information and cooperate with each other as needed. For example, each application holds information indicating that the application 800 is a first environment application product, and the application 820 is a second environment browsing optional product added to the application 800. Note that as described previously, the relationship between associated applications is not limited to this form, and applications need only be associated with each other so that they can cooperate with each other.

(Procedure)

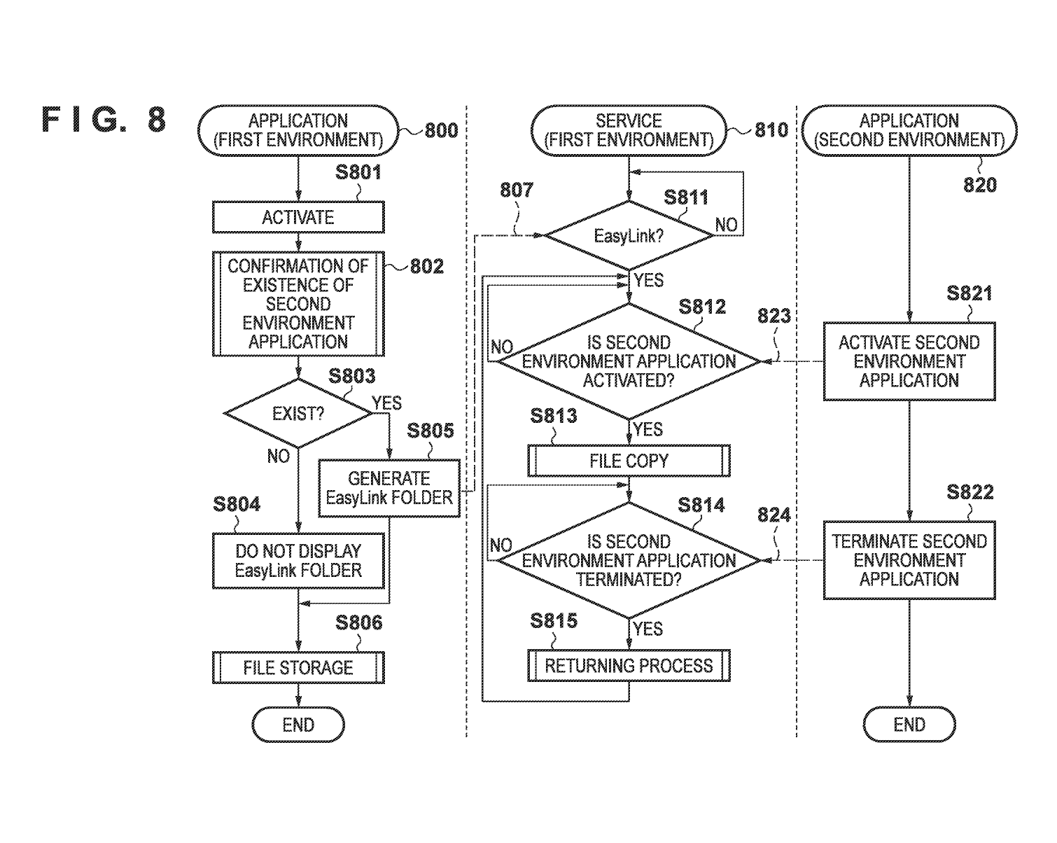

FIG. 8 is an overall flowchart of the file control process of the computer 100 according to this embodiment. The CPU 11 executes the procedure of the file control process through the OS in accordance with a program stored in the ROM 13 as a memory.

With reference to FIGS. 1 to 7, 13, 22, and 23, the procedure in which the applications cooperate with other and the second environment application can smoothly open a target file will be explained in accordance with flowcharts shown in FIGS. 8 to 12.

FIG. 8 shows the procedure in which three application processes execute processing by cooperating with each other. The application 800 is the application 2303 that operates on the first environment (the first environment software 202) shown in FIG. 23, and provides the application screen 401 shown in FIG. 4 in this embodiment. The application 800 displays the tree view and folder contents as shown in FIG. 4. Also, each application can manage files stored in the internal storage 14 and external storage 23.

The service 810 is a service that operates in the first environment. A service operating in the first environment can continue processing depending on the first environment in the background, even while a second environment application is operating.

The application 820 is the application 2305 that operates on the second environment (the second environment software 203) shown in FIG. 23, and provides the application screens 601 and 701 shown in FIGS. 6 and 7 in this embodiment. The purpose of these applications is to operate in cooperation with each other while referring to each other's information.

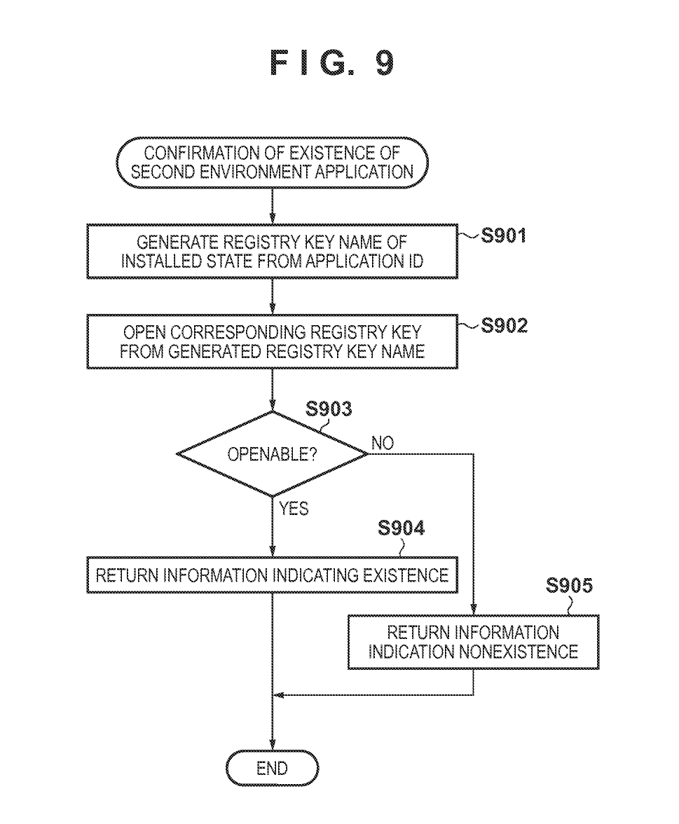

First, the operation of the first environment application 800 will be explained. In the first environment, the user gives instructions to activate the application 800 from the touch operation panel 19 or mouse 17 (step S801). Then, the application 800 checks whether the second environment application 820 as a cooperation target is installed in the same computer 100 (step S802). Details of the process in step S802 will be described later with reference to FIG. 9.

If the application 820 as a cooperation target exists (YES in step S803), the application 800 generates and displays a special folder on its own user interface displayed on the touch operation panel 19 or external display 21 (step S805). This special folder (a third holder) will be called “EasyLink folder” in this specification. On the other hand, if the application 820 as a cooperation target does not exist (NO in step S803), the application 800 does not display any EasyLink folder (step S804).

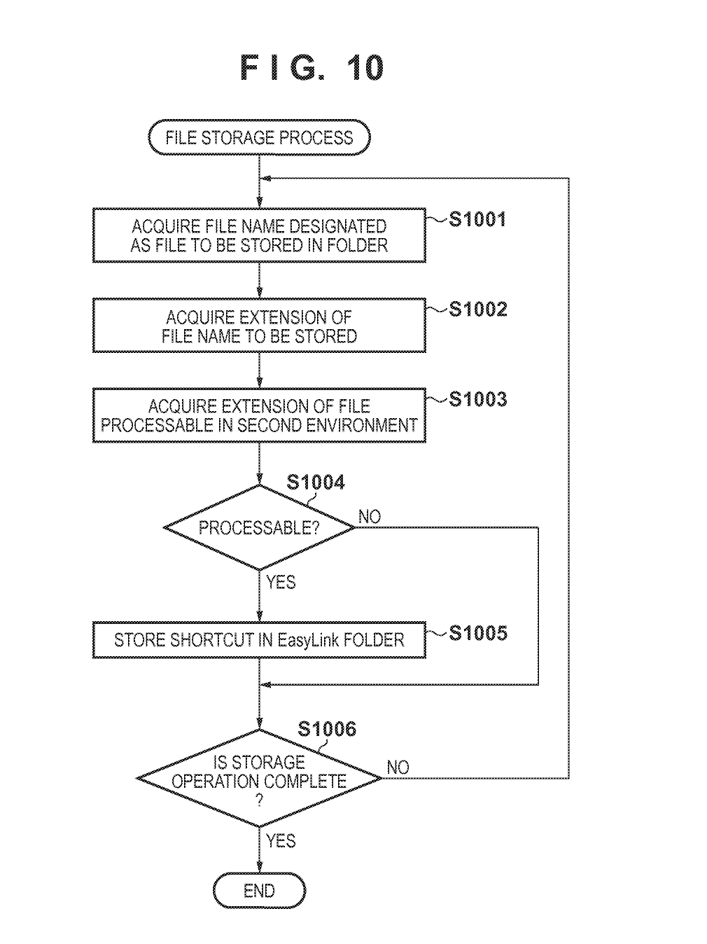

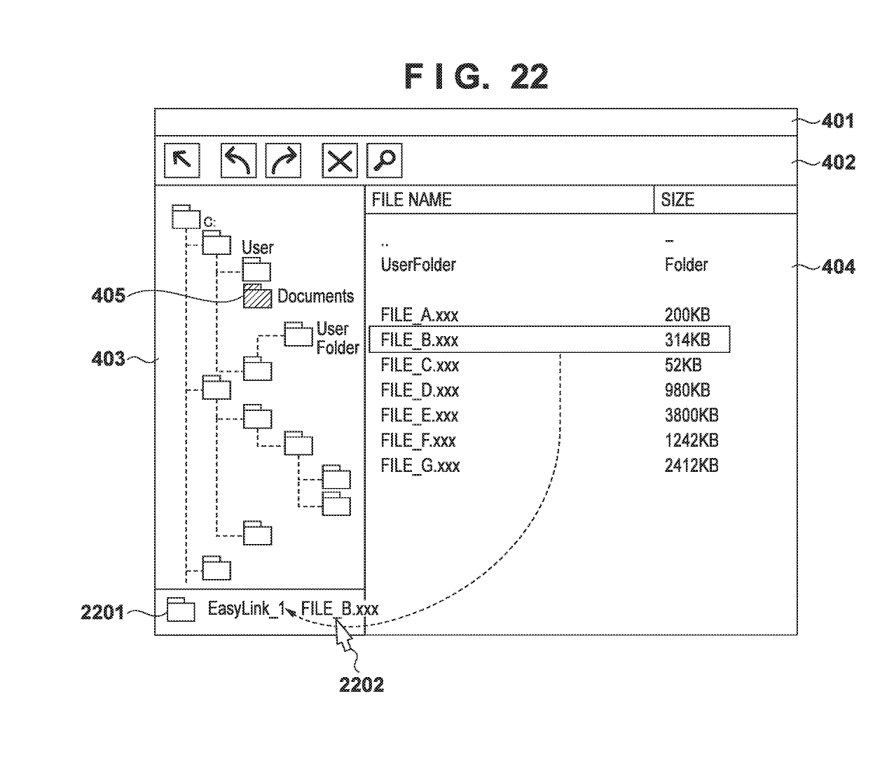

As shown in FIG. 22, the EasyLink folder is displayed (an icon 2201) in addition to the application window shown in FIG. 4. The user stores, in this EasyLink folder, a file (target data) to be used in the second environment (step S806). For example, as indicated by an icon 2202 shown in FIG. 22, a file can be stored by drag-and-drop from the pane 404 by using the mouse 17 or the like. This implements an accepting unit for accepting the designation of processing target data from the user. Details of the process in step S806 will be explained later with reference to FIG. 10.

The position of the EasyLink folder of each of the application 800 and service 810 is previously defined by programming in a given folder on the internal storage 14, and files stored in the folder can be acquired. For example, “C:¥Temp¥EasyLink” can be used as the defined folder.

(Second Environment Application Existence Checking Process)

The contents of step S802 shown in FIG. 8 will be explained in detail below with reference to FIG. 9.

First, the application 800 checks whether the second environment application 820 is installed, by using a common information database (not shown) such as a registry (for example, the Windows registry) shared by the first and second environments. For example, the Windows registry is stored in the internal storage 14, and suitably loaded to the RAM 12 and accessed. Especially in Windows 8, if there is ID information (identification information) of an application in the second environment (Metro environment), registry information generated by the Windows installer of the OS is known. Therefore, whether an application is installed can be checked by checking whether the specific registry key of the application exists. For example, determination can be performed by checking “HKEY_CurrentUser¥Software¥Classes¥Extensions¥ContactId ¥Windows.Launch¥Application ID”.

Based on the specifications of the OS, the application 800 generates a registry key name of the second environment application 820 (step S901). Then, the application 800 checks whether a key corresponding to the generated registry key name exists, by checking whether the registry information can be opened (step S902). If the information can be opened (YES in step S903), the application 800 returns, to the upper process, information indicating that the second environment application as a target “exists” (step S904). If the information cannot be opened (NO in step S903), the application 800 returns, to the upper process, information indicating that the second environment application as a target “does not exist” (step S905). After that, the application 800 terminates this process.

(File Storage Process)

The contents of step S806 shown in FIG. 8 will be explained in detail below with reference to FIG. 10. This process performs target data storage control between application execution environments using different user interfaces.

First, the application 800 acquires the file name of a file designated by the user as a file to be stored in the EasyLink folder (step S1001). Then, the application 800 acquires the extension of the designated file (step S1002). Assume that the designated file is a file “FILE_A.xxx” in a folder “C:¥AAA”. In this case, a file name “C:¥AAA¥FILE_A.xxx” is acquired in step S1001, and an extension “.xxx” is acquired in step S1002.

Also, the types of files that can be browsed by the application 820 are previously defined as extension information in the application 800. For example, processable extensions are defined as “.xxx”, “.yyy”, and “.zzz”. The application 800 acquires extension information defined as processable (step S1003). Then, the application 800 checks whether the extension information acquired in step S1003 contains the extension acquired in step S1002 (step S1004). If the extension information contains the acquired extension (YES in step S1004), the application 800 determines that the designated file can be processed in the second environment, and stores “shortcut file” of the designated file in the EasyLink folder (step S1005). If the storage process has been performed for all files (YES in step S1006), the application 800 terminates this process.

“Shortcut file” herein mentioned is a file indicating “location” of a given file on the file system. For example, a shortcut file holds only the file name “C:¥AAA¥FILE_A.xxx” as information, and actual data can be accessed from the file name “FILE_A.xxx”. The shortcut file does not hold actual data itself of the file. Note that the shortcut file is also called “alias”.

(Overall Processing (Continued))

Referring back to FIG. 8, the first environment service 810 and second environment application 820 will be explained. The purpose of these processes is to operate in cooperation with each other. Note that the service 810 starts operating at the same time the OS starts up, and stops operating when the OS stops. Accordingly, neither start nor end is clearly described on the flowchart.

First, the service 810 determines whether the EasyLink folder is generated by the application 800 (step S811). Since the application 800 and service 810 are completely independent processes, whether the application 800 is operating at the time of determination does not matter. For example, information indicating whether the EasyLink folder is generated and displayed when the application 800 is activated last time is stored in an information database (not shown) such as a registry, and the determination is performed by referring to the information (a broken-line arrow 807). If the EasyLink folder is generated (YES in step S811), the process advances to step S812. If no EasyLink folder is generated (NO in step S811), the determination process in step S811 is repeated.

In step S812, the service 810 monitors whether the application 820 is activated. Since the service 810 knows the process information of the application 820, the service 810 can detect the activation if the OS generates a process activation event (a broken-line arrow 823). Step S812 is repeated (NO in step S812) until the activation of the application 820 is detected. If the activation is detected (YES in step S812), the process advances to step S813.

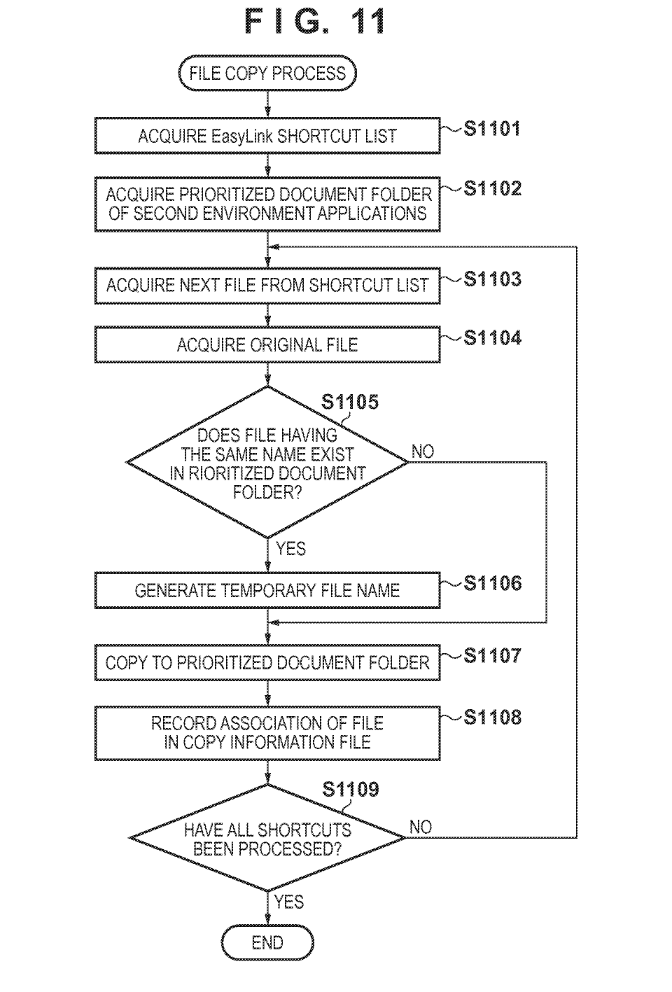

In step S813, the service 810 performs a process of copying the original file (actual data) from the original folder (a first folder) by using the shortcut file stored in the EasyLink folder generated by the application 800. Details of this process in step S813 will be described later with reference to FIG. 11.

The application 820 is activated (step S821) and terminated (step S822) between steps S812 and S814. The application 820 uses a document by displaying a file selected to be opened by the method as shown in FIG. 7. Note that a document is sometimes edited by using the application 820.

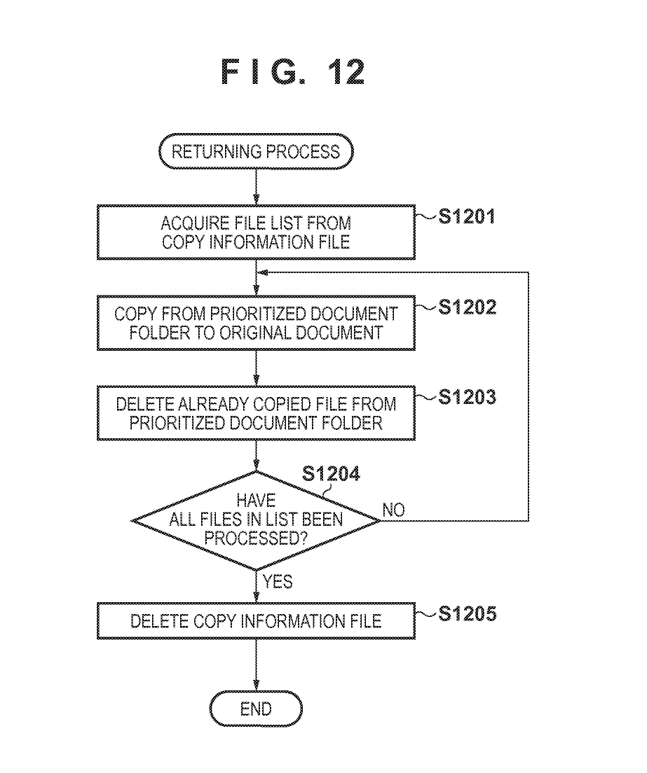

Then, the service 810 checks whether the application 820 is terminated (step S814). When the OS generates a state transition event of a process, the termination of the application 820 can be detected (a broken-line arrow 824) by determining whether the process has advanced to a terminated state. If the application 820 is terminated (YES in step S814), the service 810 returns the file copied in step S813 to the original folder position, and deletes the file in the copy destination (step S815). Details of this process in step S815 will be explained later with reference to FIG. 12. After that, the process returns to step S812, and the service 810 repeats the above-mentioned process whenever the application 820 is activated.

(File Copying Process)

The contents of step S813 shown in FIG. 8 will be explained in detail below with reference to FIG. 11.

First, the service 810 acquires the list of shortcut file names stored in the EasyLink folder (step S1101). Subsequently, the service 810 acquires information of a prioritized document folder to be used by the second environment application 820 in a process of opening a file (step S1102). “Prioritized document folder” indicates the folder name of a folder (second folder) initially displayed when the application 820 is instructed to perform a “file opening” process after being activated. This information is stored in a registry (not shown) or the like, as information that can be shared by the service 810. The prioritized document folder is a copy destination to which a file (actual data) is copied from the EasyLink folder later. That is, since the prioritized document folder is an initially displayed folder, the user can refer to data stored in this folder by operations fewer than those for other folders.

After acquiring the shortcut file list and copy destination folder name, the service 810 starts loop processing, and sequentially processes shortcut files shown in the shortcut file list acquired in step S1101. First, the service 810 acquires a shortcut file to be processed next from the shortcut file list (step S1103). Then, the service 810 acquires position information of an original file (actual data) indicated by the acquired shortcut file (step S1104). To copy the original file whose position information is acquired to the prioritized document folder (copy destination) acquired in step S1102, the service 810 checks whether the same file name exists in the copy destination (step S1105). If the same file name exists (YES in step S1105), the service 810 generates a temporarily used file name (to be referred to as a temporary file name hereinafter) different from the original file name (step S1106). Subsequently, the service 810 copies the original file (actual data) to the prioritized document folder (step S1107). After the copying, the service 810 records, in “copy information file”, the location of the original file and the file name copied to the prioritized document folder by associating them with each other (step S1108). The service 810 checks whether the above-mentioned process has been executed for all shortcut files contained in the shortcut list (step S1109). If the process has been executed (YES in step S1109), the service 810 terminates this procedure. If an unprocessed shortcut file exists (NO in step S1109), the process returns to step S1103, and the service 810 repeats the process.

“Copy information file” will be explained below. As described earlier, various files may be registered in the shortcut file list from a plurality of different folders. These files may include a plurality of files having the same file name. For example, “C:¥AAA¥FILE_B.xxx” and “C:¥BBB¥FILE_B.xxx” may be included. In this case, these files having the same name cannot simultaneously be stored in the same copy destination folder (prioritized document folder).

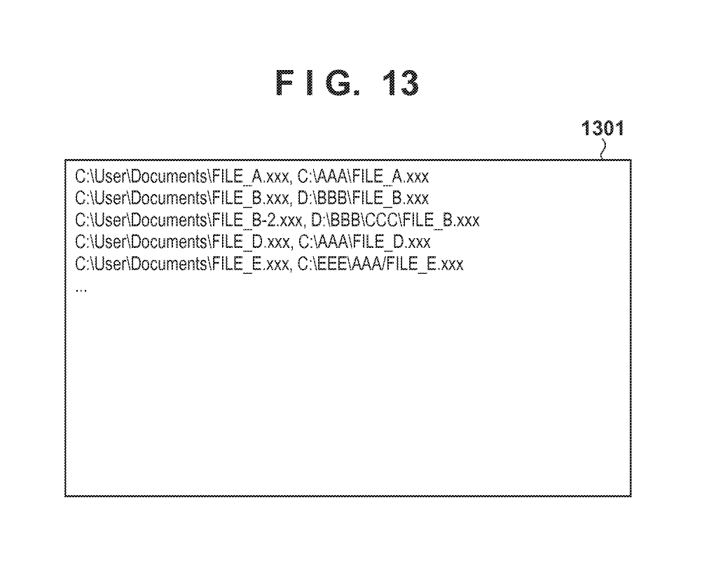

Accordingly, the process of generating and storing a temporary file name is performed in step S1106. To protect the relationship with the original file from being lost by this process, the copy source file and copy destination file are stored as they are associated with each other in a file. This file is “copy information file”. FIG. 13 shows an example of the contents of the copy information file. In a copy information file 1301 shown in FIG. 13, five files are recorded in order of “copy destination name, copy source name”, respectively. Since a plurality of files “FILE_B.xxx” exist in this example, one is copied as “FILE_B-2.xxx”. However, the relationship with the original file is not lost because the original file name is also described. The copy information file is recorded in the internal storage 14 by using a file name defined as a program of the service 810. Note that the prioritized document folder is set as “C:¥User¥Documents” in FIG. 13.

(Returning Process)

The contents of step S815 shown in FIG. 8 will be explained in detail below with reference to FIG. 12.

First, the service 810 acquires a file name relationship list stored in the copy information file (step S1201). Then, the service 810 enters a loop for processing files in the list, and copies (overwrites) a file from the prioritized document folder to data having the original file name in the original folder (step S1202). This step can be performed by copying file names described as a pair in the copy information file. In the example shown in FIG. 13, “C:¥User¥Documents¥FILE_A.xxx” is overwritten on “C:¥AAA¥FILE_A.xxx”.

Subsequently, the service 810 deletes the file in the prioritized document folder (step S1203). Consequently, the file existence state in the prioritized document folder can be returned to that before the application 820 is activated. Also, changes added by the second environment application 820 can be reflected on the original file.

After that, the service 810 checks whether the process has been performed for all files contained in the copy information file (step S1204). If the process has been performed for all files (YES in step S1204), the service 810 deletes the copy information file itself (step S1205), and terminates the process. If an unprocessed file exists (NO in step S1204), the service 810 returns to step S1202 and repeats the process.

As described above, even when an OS having a plurality of execution environments has GUIs having different execution environments, it is possible to improve the operability for a file required by the user, and improve the usability.

### Second Embodiment

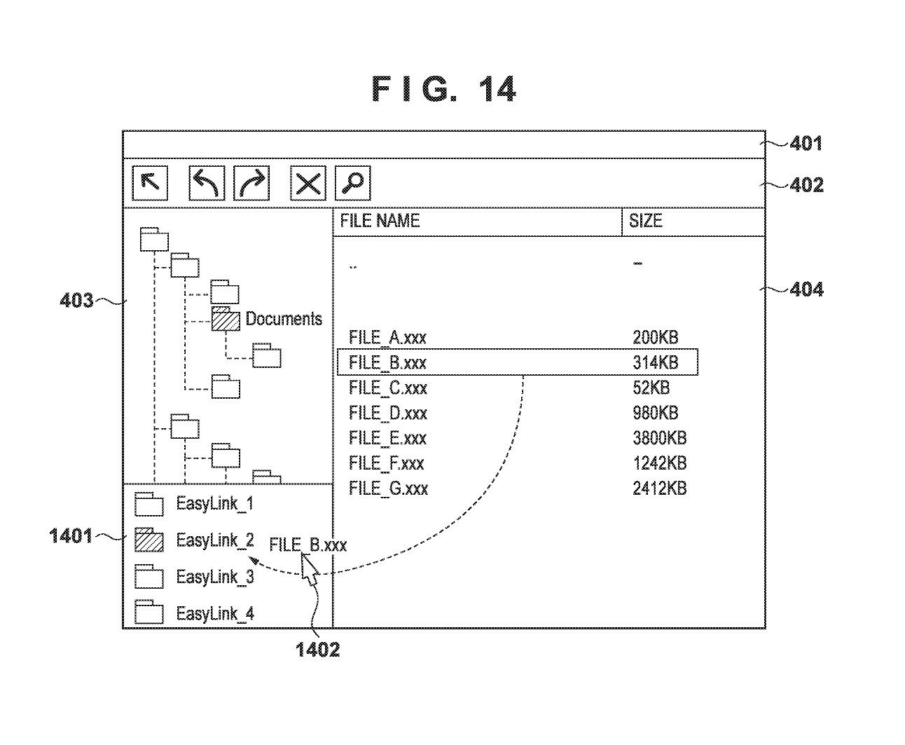

FIG. 14 is a view showing an example of the arrangement of an application 800 of the second embodiment of the present invention. FIG. 14 shows an application window displayed on a touch operation panel 19 or external display 21.

Referring to FIG. 14, a pane 1401 displays a plurality of EasyLink folders unlike in the first embodiment. The user can display and manage the plurality of EasyLink folders once generated, by using the techniques of “new file” and “delete” as generally known items. Each of the plurality of EasyLink folders can also be associated with a user's purpose or an application.

In an application screen 401, the display items of panes 402 to 404 remain unchanged. In the pane 1401, a plurality of EasyLink folders are displayed. The user can add or delete a folder to or from the region of the pane 1401, and can manage folders by giving them different names, by command operations. The user can also selectively store files in EasyLink folders by dragging and dropping each file in a desired folder as indicated by an icon 1402.

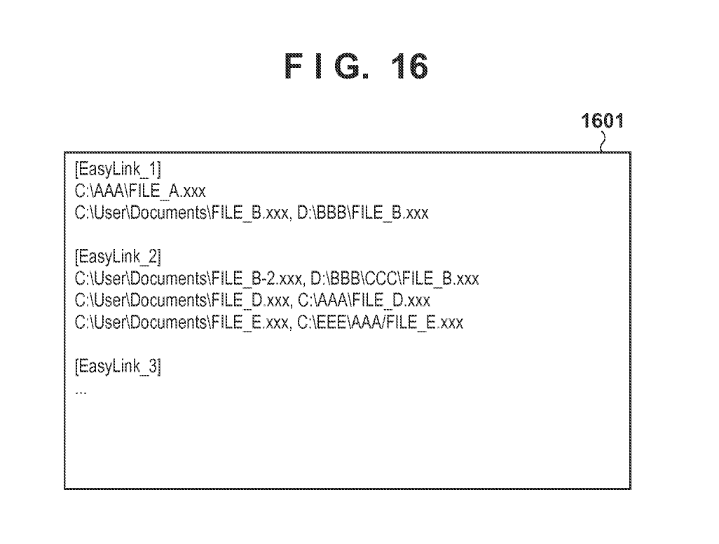

Information of EasyLink folders managed by the application 800 is stored in an internal storage 14 by a method (for example, a registry or XML file) that can be shared by a service 810, or a method unique to the system. For example, an EasyLink information file 1601 can be formed as shown in FIG. 16. In the EasyLink information file 1601 shown in FIG. 16, a shortcut list indicating the name of each EasyLink folder and the original position of each file stored in the folder is stored. This embodiment differs from the first embodiment in that neither the entity of each EasyLink folder nor the entity of each shortcut file exists, and EasyLink information is managed by the EasyLink information file 1601 shown in FIG. 16. Note that it is also possible to manage each of a plurality of EasyLink folders by using the entity of a shortcut file as in the first embodiment.

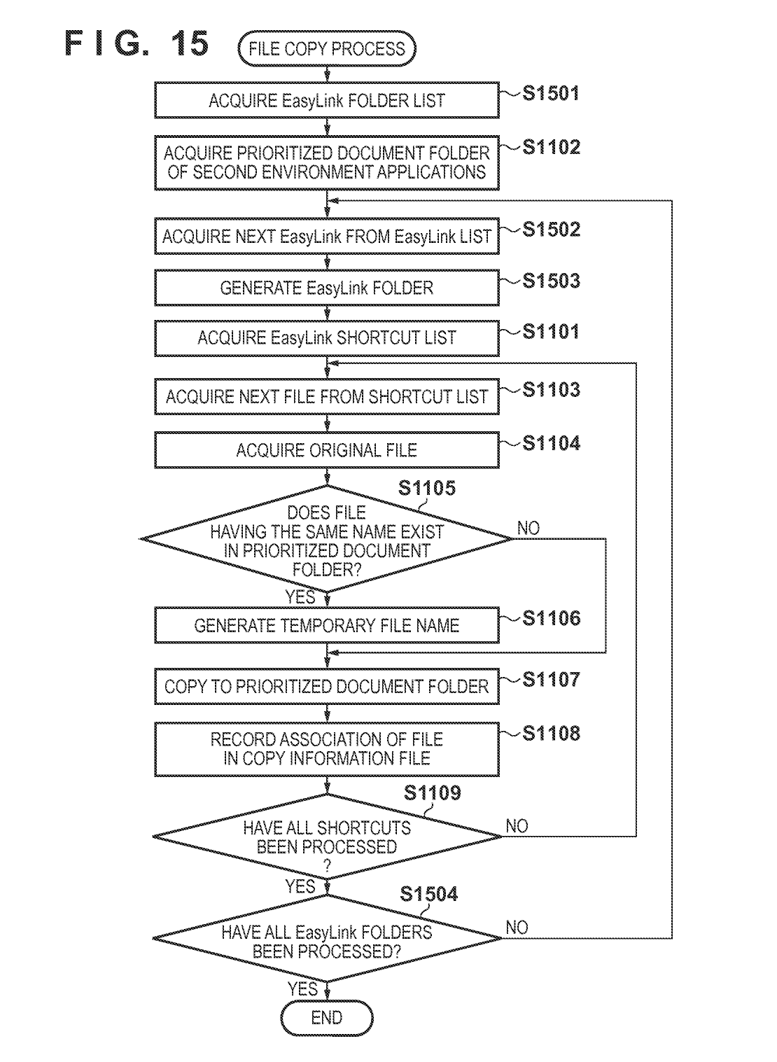

FIG. 15 is a flowchart in which the sub-flowchart shown in FIG. 11 of the first embodiment is changed to correspond to a plurality of EasyLink folders. Note that the same reference numerals as in FIG. 11 denote the same processes in FIG. 15.

First, the application of the service 810 reads the EasyLink information file 1601, and acquires a stored EasyLink folder list “EasyLink_1, EasyLink_2, EasyLink_3, . . . ” (step S1501). Subsequently, the service 810 acquires a next unprocessed EasyLink folder in order to process each folder (step S1502). The service 810 generates the acquired EasyLink folder in a prioritized document folder of a second environment application 820 (step S1503). “Generate the EasyLink folder” herein mentioned indicates that an actual folder having the same folder name as that described in the EasyLink information file is generated in the file system of the OS. Assume that the prioritized document folder is a folder “C:¥User¥Documents” and a folder name “EasyLink_1” is described in the EasyLink information file. In this case, a folder “C:¥User¥Documents¥EasyLink_1” is generated as a sub-folder of the prioritized document folder. Each file (actual data) is copied to this generated folder in a subsequent step.

Steps S1102 to S1115 after that are processes of copying a file in each folder. Since, however, the processing contents are the same as those of the flowchart shown in FIG. 11, an explanation thereof will be omitted. After that, the service 810 checks whether all EasyLink folders have been processed (step S1504). If all EasyLink folders have been processed (YES in step S1504), the service 810 terminates this procedure. If an unprocessed EasyLink folder exists (NO in step S1504), the service 810 returns to step S1502 and repeats the process.

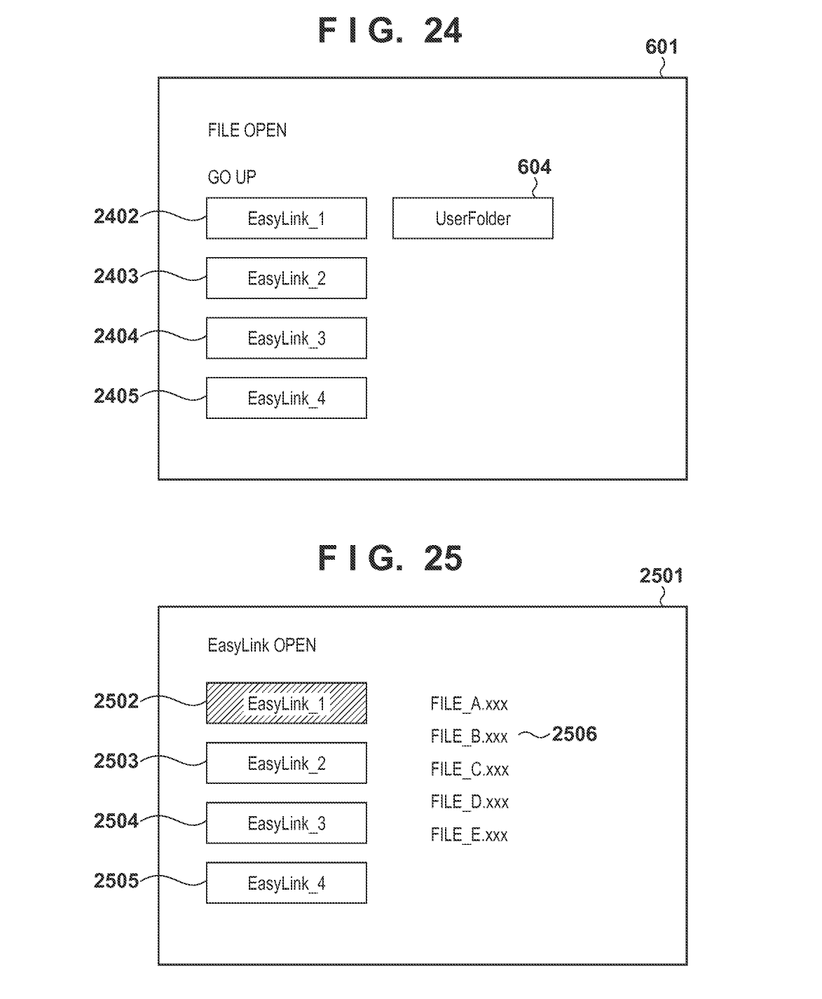

FIG. 24 shows an example in which an application screen 601 of the application 820 is displayed on the touch operation panel 19 in the second embodiment. FIG. 24 shows the way a plurality of EasyLink folders 2402 to 2405 are generated when the application 820 is executed. Note that the folder item 604 formed by the user and originally stored on the file system remains on the application screen 601 and coexists.

[Effect Unique to this Embodiment]

In the arrangement of this embodiment, the user selects an appropriate file from a plurality of EasyLink folders based on his or her own management settings. Accordingly, the user can access a set of files corresponding to a plurality of statuses by a small number of steps.

### Third Embodiment

FIG. 25 is a view showing an example of the arrangement of a data selection screen of an application 820 according to the third embodiment of the present invention.

Referring to FIG. 25, a plurality of EasyLink folders are displayed, but an application screen 2501 is a unique component independent of the file selection screen provided by the OS unlike in the second embodiment. Therefore, this screen can also be a component unique to the application.

A service 810 copies a file based on an EasyLink information file 1601 described in the second embodiment. In this process, the copy destination is a given specific folder in an internal storage 14, which is predetermined when designing the application 820. An example is a folder “C:¥Temp¥EasyLinks”. This folder is an exclusive folder for storing files required by only the system of the present invention. The application 820 capable of accessing this exclusive folder processes a folder in the exclusive folder based on the assumption that the folder is based on EasyLink information.

The application 820 displays a list of EasyLink folders (EasyLink folders 2502 to 2505) on the left side as shown in FIG. 25. Assume that the user has selected the EasyLink folder 2502 from among the displayed EasyLink folders. In this case, the EasyLink folder 2502 is set in a state indicating the selection, and a list of files contained in the EasyLink folder 2502 is displayed on a right side 2506 of the screen. Note that the layout for displaying folders and files is not limited to this, and can also be changed in accordance with the user's settings.

[Effect Unique to this Embodiment]

In the arrangement of this embodiment, the user can exclusively display only an EasyLink folder list without performing operations “Go Up” and “Open Folder”. Since the user can directly access each EasyLink folder and display its contents, it is possible to move between a plurality of folders with fewer procedures.

### Fourth Embodiment

Each of the first to third embodiments described above is configured based on the premise that the application 800, service 810, and application 820 closely cooperate with each other based on each other's information. That is, these applications and service corporate with each other based on the assumption that they hold each other's information such as product packages as information designated by the same developer.

In the fourth embodiment, an application and service operating in the first embodiment cooperate with each other, but an application operating in the second environment is not developed by the same developer (vender). Even in this case, these applications are “associated” with each other.

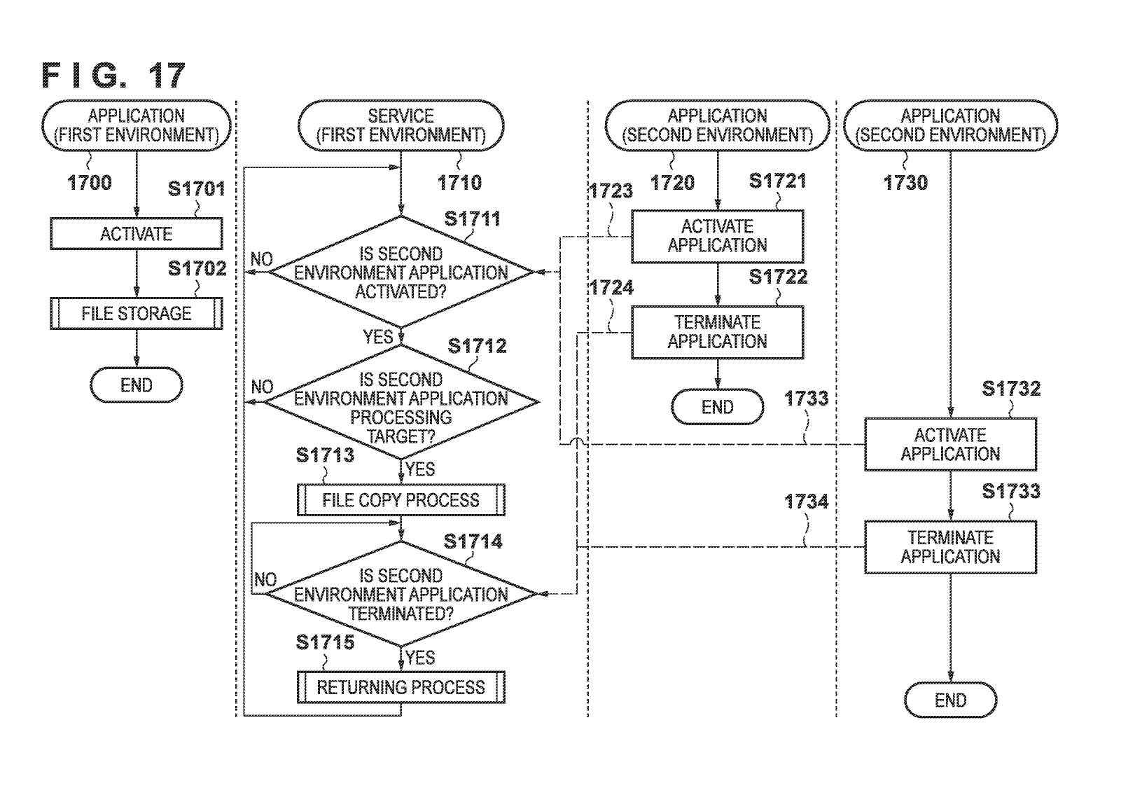

FIG. 17 is an overall flowchart of a file control process of a computer 100 according to this embodiment. With reference to the flowchart shown in FIG. 17 in addition to the above-mentioned drawings, a procedure capable of smoothly opening a target file in a second environment application by the cooperation of the first and second environments will be explained below.

FIG. 17 shows four processes. An application 1700 is a first environment application that operates in the first environment like the application 800 of the first embodiment. However, unlike in the first embodiment, this application always displays EasyLink folders in a pane 1401 as shown in FIG. 14. The processes shown in FIG. 17 will be explained based on this assumption.

When the application 1700 is activated (step S1701), the user stores a shortcut file of a file (actual data) in an EasyLink folder as in the first embodiment (step S1702). Unlike in the first embodiment, however, the process of selecting whether to store each file in accordance with the extension (steps S803 to S805 shown in FIG. 8) is not performed in step S1702. That is, all shortcut files of designated files can be stored in the EasyLink folders.

A service 1710 is a service that operates in the first environment, like the service 810 of the first embodiment. The purpose of the service 1710 is to operate in cooperation with second environment applications 1720 and 1730. The service 1710 basically starts operating at the same time the OS starts up, and stops operating when the OS stops. Accordingly, neither “start” nor “end” is clearly described in the flowchart.

The service 1710 detects whether the applications 1720 and 1730 are activated in accordance with application activation events (broken-line arrows 1723 and 1733) generated from the OS (step S1711). If the activation is detected (YES in step S1711), the service 1710 determines whether the detected application is a processing target of the service 1710 (step S1712).

The service 1710 holds a list of applications as file processing targets of EasyLink folders, in the program or on an internal storage 14. However, the service 1710 and applications 1720 and 1730 are not developed by the same developer (vender) as described above. Accordingly, process information of a second environment application must be open to the public by the developer of the application, or the service 1710 must have information analyzed by reverse engineering. Based on this premise, the service 1710 can determine whether an application is a processing target of an EasyLink folder by referring to hard-coded process information of the application.

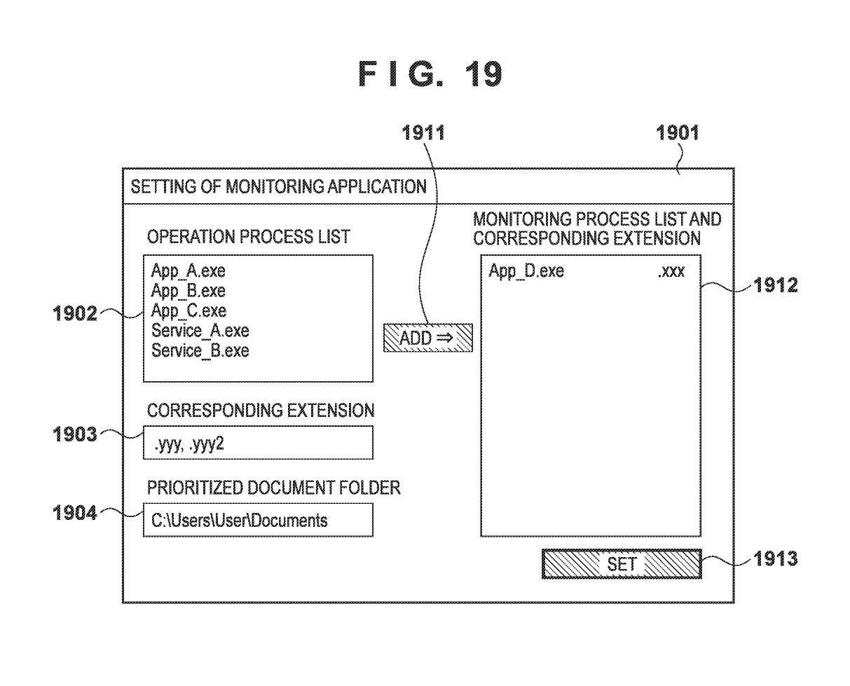

Alternatively, it is also possible to allow the user to freely register process information of a processing target on a setting screen displayed by the application 1700 as shown in FIG. 19. A setting screen 1901 displays a list 1902 of processes operating on the OS, based on information acquirable from the OS. From this list, the user selects an application as a processing target of an EasyLink folder.

Furthermore, the user inputs, to an item 1903, the extension of a file to be copied from an EasyLink folder by using the selected process information. Also, the user inputs a prioritized document folder of the selected application to an item 1904. When completing proper selection and input, the user registers additional information such as the process and extension in a monitoring process list 1912 by using an addition button 1911. After that, the user closes the setting screen 1901 by using a setting button 1913. The user can register the process information in the service 1710 on the setting screen 1901.

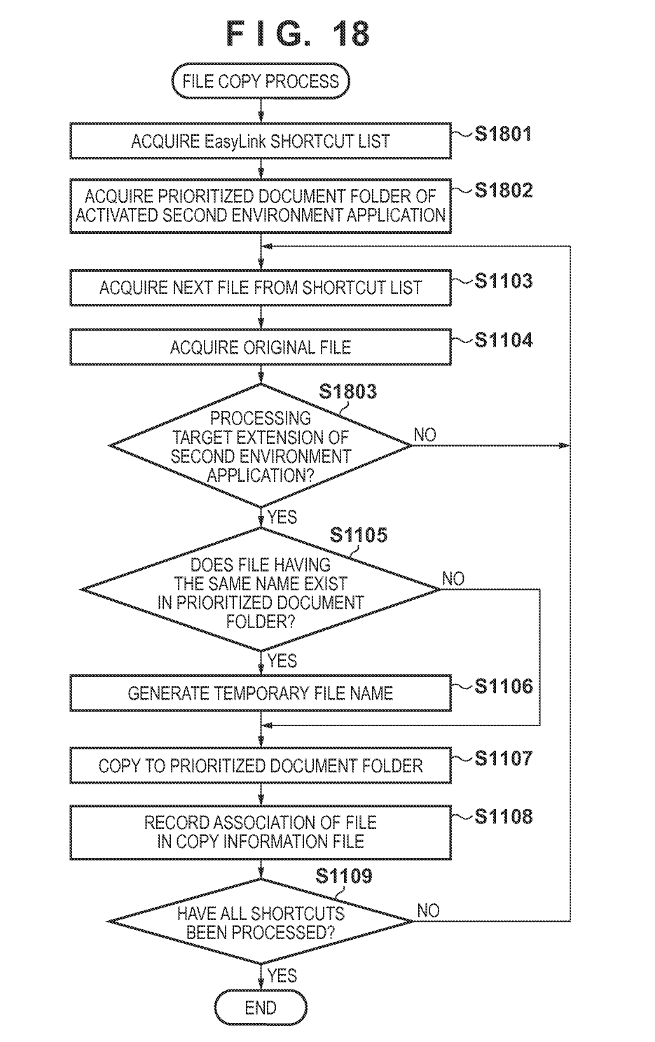

Referring back to the flowchart shown in FIG. 17, when the applications 1720 and 1730 found to be monitoring targets are activated, the service 1710 executes a process of copying a target file (actual data) from an EasyLink folder (step S1713). This process in step S1713 will be described later with reference to FIG. 18. After that, the service 1710 waits for the termination of the applications (broken-line arrows 1724 and 1734) (YES in step S1714), and performs a process of returning the copied file (step S1715). The process in step S1715 is the same as the process shown in FIG. 12, so an explanation thereof will be omitted. Then, the process returns to step S1711, and the service 1710 repeats the same process whenever the applications 1720 and 1730 are activated.

Steps S1721, S1722, S1731, and S1732 in which the second environment applications 1720 and 1730 are activated and terminated are equal to steps S821 and S822 shown in FIG. 8 of the first embodiment, so a detailed explanation thereof will be omitted.

(File Copying Process)

The contents of step S1713 shown in FIG. 17 will now be explained in detail with reference to FIG. 18.

The service 1710 acquires a shortcut file list stored in an EasyLink folder (step S1801). Also, the service 1710 acquires information of a prioritized document folder to be used by the second environment applications 1720 and 1730 when opening a file (step S1802). If “prioritized document folder” is disclosed as process information, information of a display folder when opening a file upon the next activation can be acquired from, for example, a registry. Alternatively, the prioritized document folder can be set from the item 1904 of the setting screen 1901 shown in FIG. 19. This prioritized document folder is a copy destination to which a file (actual data) is copied from the EasyLink folder later.

After the shortcut file list and copy destination folder name are acquired, the service 1710 sequentially processes shortcut files contained in the list acquired in step S1801. Steps S1103 to S1109 after that are the same as those shown in FIG. 11, so an explanation thereof will be omitted. Note that in step S1803 after step S1104 during this process, the service 1710 determines whether a file being processed is a processing target of the second environment application whose activation is detected, by comparing extensions registered as processing target extensions (step S1803). If “processing target extension” is disclosed as process information, a list of extensions associated with an execution file of the process can be acquired from, for example, a registry. Alternatively, the processing target extension can be set from the item 1903 of the setting screen 1901 shown in FIG. 19.

[Effect Unique to this Embodiment]

In the arrangement of this embodiment, the same effect as that of the first embodiment can be obtained even when a second environment application is not developed by the same developer (vender) as that of a first environment application. That is, the existence of a second environment application is confirmed based on conditions set in the first environment. Then, a file is copied and deleted at the timings of the activation and termination of the application. This improves the usability for opening a file in an arbitrary second environment application.

### Fifth Embodiment

The fifth embodiment is an extension of the second embodiment. In the second embodiment, a plurality of EasyLink folders can be generated and managed as shown in FIG. 14. In the fifth embodiment, only an EasyLink folder suited to the situation is selectively copied from among the plurality of EasyLink folders. “Suited to the situation” herein mentioned indicates an operation of switching processes by judging the present situation of a computer.

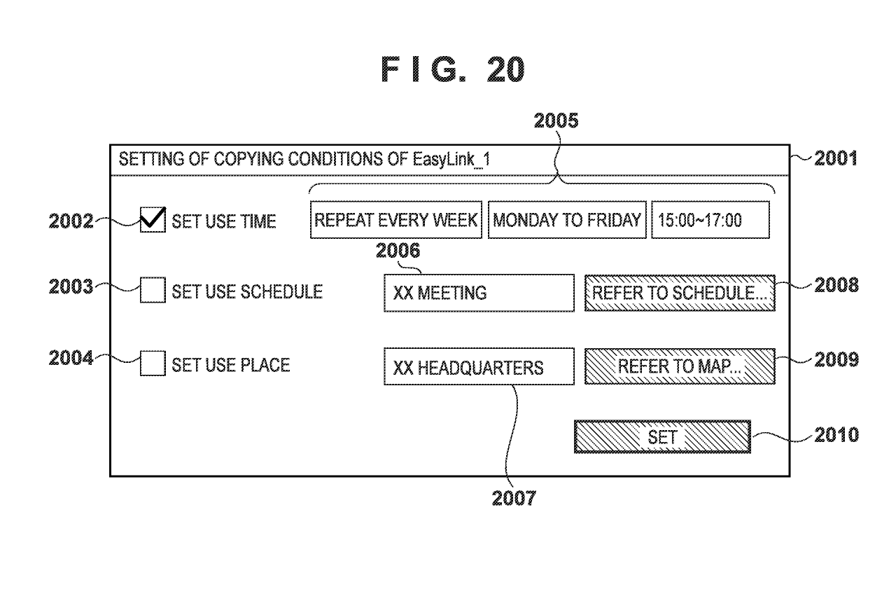

FIG. 20 shows an example of a setting screen of the fifth embodiment of the present invention. An application 800 displays this setting screen on a touch operation panel 19 or external display 21. A setting screen 2001 shows the way the copying conditions of a folder “EasyLink_1” as one EasyLink folder are set. The setting screen 2001 shows the following three examples of the copying conditions.

The first setting item is the setting of the use time of a second environment application. When the user checks a check box 2002, this setting is validated, and the EasyLink folder is set to be copied in step S813 shown in FIG. 8 only during a specific time zone of a day, which is set by an item 2005. The contents of the item 2005 are well-known setting contents generally used to set a time zone.

The second setting item is the setting of the user schedule of the second environment application. When the user checks a check box 2003, this setting is validated, and the EasyLink folder is set to be copied in step S813 shown in FIG. 8 only during a specific scheduled time zone of a specific day. An item 2006 represents the name of a schedule defined by a scheduler or the like. The user can select schedule information by using a button 2008, in cooperation with a scheduler managed by the OS or the like. The contents are well known in, for example, a general schedule management application. For example, information can be exchanged by using a versatile format such as “iCalendar”.

The third setting item is the setting of position information of a computer 100. When the user checks a check box 2004, this setting is validated, and the EasyLink folder is set to be copied only when the computer 100 exists in a specific place. An item 2007 represents the name of “position” defined by a map information application (not shown) or the like. This setting is based on the premise that the computer 100 incorporates a GPS (Global Positioning System) or has a function (not shown) of specifying the position by exchanging information with a LAN or cell phone channel. The user can select registered position information by using a button 2009, in cooperation with a map information application managed by the OS or the like. The contents are well known in, for example, a general map information application.

Note that although the above three setting items are taken as examples in this embodiment, it is of course also possible to use other setting items as the copying conditions, provided that the method can set the use conditions of a folder in the same way as above. For example, items can also be set in accordance with the authority of the user using the second environment, or the purpose of a second environment application.

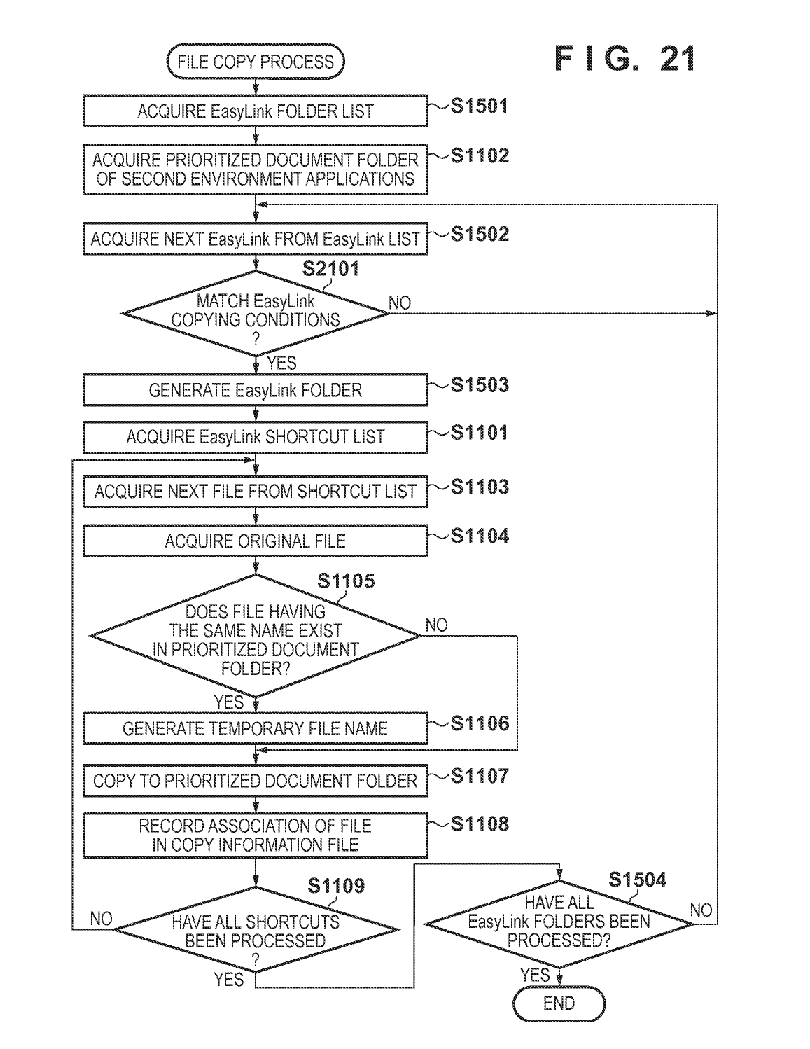

The EasyLink folder copying conditions set as described above are used in determination in a sub-flowchart shown in FIG. 21. In step S2101, a service 810 determines whether the time, date, position information, and the like acquired from the OS by a CPU 11 at that point of time match the above-described setting conditions. If the two sets of setting conditions match (YES in step S2101), the service 810 advances to step S1503 as a process of copying the EasyLink folder. Processes in steps S1501 to S1504 and S1101 to S1107 are the same as those shown in FIG. 15, so an explanation thereof will be omitted.

[Effect Unique to this Embodiment]

In the arrangement of this embodiment, it is possible to selectively copy only a necessary folder in accordance with the purpose or the situation in which the computer is placed, even when a large number of EasyLink folders are generated. When opening a file in the second environment, therefore, the target file can be found from narrowed down necessary EasyLink folders. This improves the usability of file operations in a second environment application.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-025536, filed Feb. 8, 2012, which is hereby incorporated by reference herein in its entirety.

What is claimed is:

1. An information processing apparatus installed with an operating system having a plurality of application execution environments different in user interface configuration for operating an application, comprising:
a confirmation unit configured to, when operating a first application which operates on a first application execution environment, confirm whether a second application which operates on a second application execution environment and is associated with the first application is installed on the second application execution environment; and
a storing control unit configured to, when selecting data from a data selection screen displayed by the second application after said confirmation unit has confirmed that the second application associated with the first application is installed on the second application execution environment, store the data in a second folder accessible by operations fewer than operations when accessing a first folder in which the data stored on the first application execution environment is stored.

2. The apparatus according to claim 1, wherein
the first application execution environment is an environment in which a plurality of folder layers for storing data is configured to be displayed on one screen, and
the second application execution environment is an environment in which only one folder layer for storing data is configured to be displayed on one screen.

3. The apparatus according to claim 1, wherein the second application displays data contained in the second folder on the data selection screen.

4. The apparatus according to claim 1, further comprising an accepting unit configured to accept designation of target data to be stored in the second folder by said storing control unit.

5. The apparatus according to claim 4, wherein when accepting the designation of target data, said accepting unit stores a shortcut of the target data in a third folder.

6. The apparatus according to claim 5, wherein said storing control unit stores, in the second folder, actual data corresponding to the shortcut stored in the third folder by using information of the shortcut.

7. The apparatus according to claim 5, wherein the first application provides a screen for displaying the third folder.

8. The apparatus according to claim 7, wherein when the second application is installed, the third folder is displayed on the screen provided by the first application.

9. The apparatus according to claim 5, wherein the third folder comprises a plurality of folders formed in accordance with a user's setting.

10. The apparatus according to claim 8, wherein when a plurality of folders are set as the third folder, said storing control unit stores, in the second folder, actual data designated for each folder.

11. The apparatus according to claim 1, wherein when a plurality of folders are displayed on the data selecting screen and a user has selected a given folder, data contained in the selected folder is displayed on the data selecting screen.

12. The apparatus according to claim 1, wherein said confirmation unit confirms whether the second application is installed, by using application information registered in a registry managed by the operating system.

13. The apparatus according to claim 1, further comprising a monitoring unit configured to monitor activation and termination of the second application,
wherein if said monitoring unit detects that the second application is activated, said storing control unit stores the data in the second folder.

14. The apparatus according to claim 13, wherein if said monitoring unit detects that the second application is terminated, said storing control unit copies the data stored in the second folder to the first folder.

15. The apparatus according to claim 1, wherein said storing control unit provides a setting screen for setting a condition for storing, in the second folder, data stored in the first folder.

16. The apparatus according to claim 15, wherein the condition is time at which the second application is executed.

17. The apparatus according to claim 15, wherein the condition is a position of the apparatus when the second application is executed.

18. An information processing apparatus installed with an operating system having a plurality of application execution environments different in user interface configuration for operating an application, comprising:
a confirmation unit configured to, when operating a first application which operates on a first application execution environment, confirm whether a second application which operates on a second application execution environment and is associated with the first application is activated on the second application execution environment; and
a storing control unit configured to, when selecting data from a data selection screen displayed by the second application after said confirmation unit has confirmed that the second application associated with the first application is activated on the second application execution environment, store the data in a second folder accessible by operations fewer than operations when accessing a first folder in which the data stored on the first application execution environment is stored.

19. The apparatus according to claim 18, wherein if it is confirmed that the second application is terminated on the second application execution environment, said storing control unit copies the data stored in the second folder to the first folder.

20. The apparatus according to claim 19, further comprising a setting unit configured to accept setting of a second application as a target of activation confirmation by said confirmation unit.

21. An information processing method of an information processing apparatus installed with an operating system having a plurality of application execution environments different in user interface configuration for operating an application, comprising:
confirming, when operating a first application which operates on a first application execution environment, whether a second application which operates on a second application execution environment and is associated with the first application is installed on the second application execution environment; and
storing, when selecting data from a data selection screen displayed by the second application after it is confirmed in the confirming step that the second application associated with the first application is installed on the second application execution environment, the data in a second folder accessible by operations fewer than operations when accessing a first folder in which the data stored on the first application execution environment is stored.

22. An information processing method of an information processing apparatus installed with an operating system having a plurality of application execution environments different in user interface configuration for operating an application, comprising:
confirming, when operating a first application which operates on a first application execution environment, whether a second application which operates on a second application execution environment and is associated with the first application is activated on the second application execution environment; and
storing, when selecting data from a data selection screen displayed by the second application after it is confirmed in the confirming step that the second application associated with the first application is activated on the second application execution environment, the data in a second folder accessible by operations fewer than operations when accessing a first folder in which the data stored on the first application execution environment is stored.

23. A non-transitory computer-readable medium storing a program which causes a computer to function as:
a confirmation unit configured to, when operating a first application which operates on a first application execution environment, confirm whether a second application which operates on a second application execution environment and is associated with the first application is installed on the second application execution environment; and
a storing control unit configured to, when selecting data from a data selection screen displayed by the second application after said confirmation unit has confirmed that the second application associated with the first application is installed on the second application execution environment, store the data in a second folder accessible by operations fewer than operations when accessing a first folder in which the data stored on the first application execution environment is stored.

24. A non-transitory computer-readable medium storing a program which causes a computer to function as:
a confirmation unit configured to, when operating a first application which operates on a first application execution environment, confirm whether a second application which operates on a second application execution environment and is associated with the first application is activated on the second application execution environment; and
a storing control unit configured to, when selecting data from a data selection screen displayed by the second application after said confirmation unit has confirmed that the second application associated with the first application is activated on the second application execution environment, store the data in a second folder accessible by operations fewer than operations when accessing a first folder in which the data stored on the first application execution environment is stored.
